(19) United States
(12) Patent Application Publication
(10) Pub. No.: US 2019/0379192 A1
(43) Pub. Date: Dec. 12, 2019

(54) ELECTRICAL JUNCTION BOX

(71) Applicant: Sumitomo Wiring Systems, Ltd., Yokkaichi (JP)

(72) Inventor: Hiroki Yoshihara, Yokkaichi (JP)

(21) Appl. No.: 16/436,144

(22) Filed: Jun. 10, 2019

(30) Foreign Application Priority Data
Jun. 11, 2018 (JP) 2018-111321

(51) Int. Cl. H02G 3/08; H02G 3/14

(52) U.S. Cl. CPC H02G 3/088; H01R 25/006; H02G 3/14; H02G 3/081

(57) ABSTRACT

Provided is an electrical junction box capable of preventing the entry of water into an accommodating box. An electrical junction box interconnects a plurality of external devices via an electrical device accommodated in an accommodating box. An opening of the accommodating box of the electrical junction box is closed by a lid. An annular sealing member is arranged along the opening of the accommodating box on the outer surface of the accommodating box, and is in intimate contact with the outer surface of the accommodating box and the inner surface of the lid. Side walls of the lid face the sealing member at a distance in a direction along the outer surface of the accommodating box.

### CROSS-REFERENCE TO RELATED APPLICATIONS

This application claims priority of Japanese Patent Application No. JP 2018-111321 filed on Jun. 11, 2018, the contents of which are incorporated herein.

### TECHNICAL FIELD

The present disclosure relates to an electrical junction box.

### BACKGROUND

A vehicle is often provided with an electrical junction box (see JP 2017-200269A, for example) that interconnects a plurality of in-vehicle devices. The in-vehicle devices are a battery, a lamp, a motor, or the like. In the electrical junction box described in JP 2017-200269A, an electrical device to be connected to the plurality of in-vehicle devices is accommodated in the accommodating box. The accommodating box is provided with an opening. The opening of the accommodating box is closed by a lid.

### SUMMARY

When a vehicle is washed with water, or when a vehicle runs in rain, the electrical junction box may get wet. In the electrical junction box described in JP 2017-200269A, the lid is in the form of box whose one side is open, and the side walls of the lid overlap the side walls of the accommodating box. If a gap is formed between the side walls of the accommodating box and the lid due to manufacturing errors, wear, corrosion or the like, water may enter the accommodating box from this gap. If water enters the accommodating box, the water may come in contact with the electrical device, and the electrical device may be broken.

The present disclosure has been made in view of such circumstances, and an object thereof is to provide an electrical junction box capable of preventing the entry of water into an accommodating box.

An electrical junction box according to one aspect of the present disclosure is an electrical junction box for accommodating an electrical device and interconnecting a plurality of external devices via the accommodated electrical device, the electrical junction box including: an accommodating box having an opening and accommodating the electrical device; a lid closing the opening; and an annular sealing member that is arranged along the opening on the outer surface of the accommodating box, and is in intimate contact with the outer surface of the accommodating box and the inner surface of the lid, and the lid has an opposing wall facing the sealing member at a distance in a direction along the outer surface of the accommodating box.

According to the above aspect, the entry of water into the accommodating box can be prevented.

### BRIEF DESCRIPTION OF THE DRAWINGS

FIG. 1 is a perspective view showing the appearance of an electrical junction box in a first embodiment.

FIG. 2 is a block diagram for explaining the operation of the electrical junction box.

FIG. 3 is a partial cross-sectional view of the electrical junction box taken along line A-A in FIG. 1.

FIG. 4 is a partial cross-sectional view of the electrical junction box taken along line B-B in FIG. 1.

FIG. 5 is a plan view of the electrical junction box from which a lid is removed.

FIG. 6 is a cross-sectional view of a sealing member.

FIG. 7 is a perspective view showing the appearance of an electrical junction box in a second embodiment.

FIG. 8 is a partial cross-sectional view of the electrical junction box.

FIG. 9 is a bottom plan view of the electrical junction box from which a lid is removed.

FIG. 10 is a view explaining the manufacturing method of the electrical junction box.

### DETAILED DESCRIPTION OF PREFERRED EMBODIMENTS

First, the embodiments of the present disclosure will be listed and described. At least some of the embodiments described below may also be combined as appropriate.

An electrical junction box according to one aspect of the present disclosure is an electrical junction box for accommodating an electrical device and interconnecting a plurality of external devices via the accommodated electrical device, the electrical junction box including: an accommodating box having an opening and accommodating the electrical device; a lid closing the opening; and an annular sealing member that is arranged along the opening on an outer surface of the accommodating box, and that is in intimate contact with (e.g. areal contact with, abutting against) the outer surface of the accommodating box and an inner surface of the lid, and the lid includes an opposing wall facing the sealing member at a distance in a direction along the outer surface of the accommodating box.

In the above aspect, the annular sealing member is arranged along the opening on the outer surface of the accommodating box, and the sealing member is in intimate contact with the outer surface of the accommodating box and the inner surface of the lid. Accordingly, the entry of water into the accommodating box is prevented. Also, because the opposing wall is provided in the lid, no water directly contacts the sealing member, and thus the sealing member is less likely to be worn away. Furthermore, because a gap is formed between the sealing member and the opposing wall, the impact of water hitting the sealing member is weak. For this reason, the sealing member is even less likely to be worn away.

In the electrical junction box according to one aspect of the present disclosure, the accommodating box may include a second opposing wall that protrudes from an edge portion of the opening and that faces the sealing member, and the sealing member may be arranged between the opposing wall and the second opposing wall.

In the above aspect, because the second opposing wall is provided, positioning of the annular sealing member in manufacturing is easy.

In the electrical junction box according to one aspect of the present embodiment, the distance between the sealing member and the opposing wall may be longer than the distance between the sealing member and the second opposing wall.

In the above aspect, the sealing member is arranged at a position closer to the second opposing wall than to the opposing wall.

In the electrical junction box according to one aspect of the present disclosure, the sealing member may include a plurality of annular abutting portions in intimate contact with the accommodating box and the lid, and an annular non-abutting portion that is connected to two of the plurality of abutting portions, and that is separated from the accommodating box and the lid.

In the above aspect, because the sealing member is in intimate contact with the accommodating box and the lid at a plurality of locations, the entry of water into the accommodating box is more reliably prevented.

In the electrical junction box according to one aspect of the present disclosure, the lid may be in the form of box whose one side is open, and the opposing wall may be the side wall of the lid.

In the above aspect, the bottom wall of the lid closes the opening of the accommodating box, and the side walls of the lid face the sealing member.

Specific examples of the electrical junction box according to the embodiments of the present disclosure will be described below with reference to the drawings. It should be noted that the present disclosure is not limited to these illustrative examples, and is indicated by the claims, and meanings equivalent to the claims and all changes within the technical scope are intended to be encompassed herein.

### First Embodiment

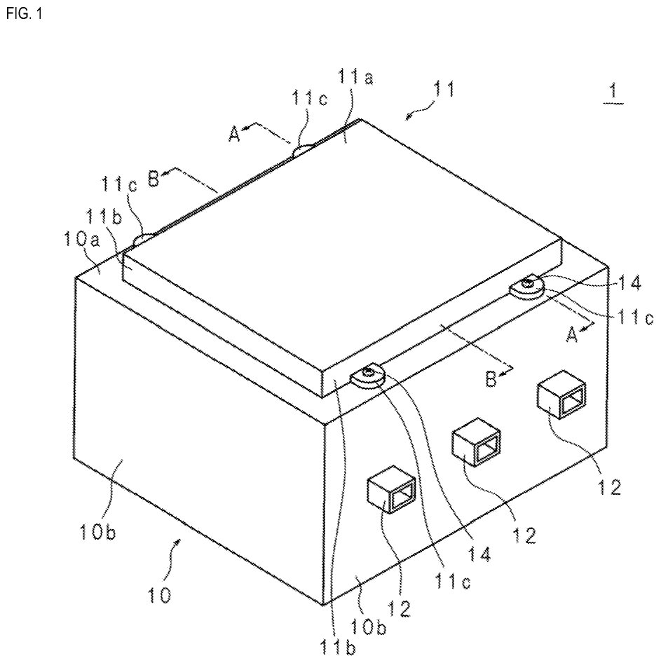

FIG. 1 is a perspective view showing the appearance of an electrical junction box 1 in the first embodiment. The electrical junction box 1 is suitably installed in a vehicle. As shown in FIG. 1, an accommodating box 10 is arranged on the lower side of the electrical junction box 1, and a lid 11 is arranged on the upper side of the electrical junction box 1. The accommodating box 10 has a hollow cuboid shape. The lid 11 is fixed to the upper surface of an upper wall 10a of the accommodating box 10. A plurality of connectors 12 are provided on one side wall 10b of the accommodating box 10. FIG. 1 shows an example in which the number of connectors 12 is three.

The accommodating box 10 and the lid 11 are made of metal such as aluminum, aluminum alloy, or aluminum oxide. Outer surfaces of the accommodating box 10 and the lid 11 are coated with a paint for preventing salt damage. The paint for preventing salt damage is a paint having high salt resistance such as a fluorine-based paint or an acrylic silicone resin. If water containing salt, or salt or the like carried by wind contacts the outer surfaces of the accommodating box 10 and the lid 11, salt may adhere to these outer surfaces. Even in this case, because the outer surfaces of the accommodating box 10 and the lid 11 are coated with the paint for preventing salt damage, the corrosion of the outer surfaces caused by salt is suppressed.

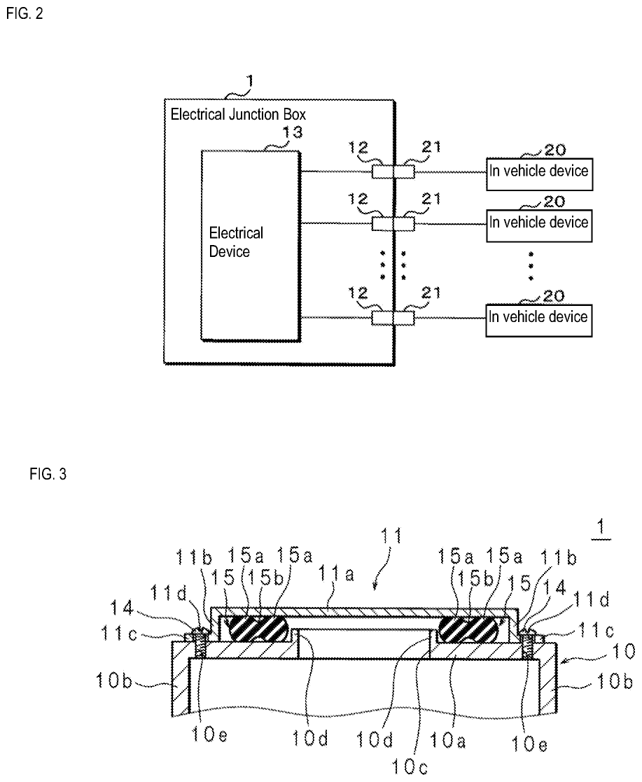

FIG. 2 is a block diagram for explaining the operation of the electrical junction box 1. An electrical device 13 is accommodated in the accommodating box 10 of the electrical junction box 1. The electrical device 13 is separately connected to the plurality of connectors 12. Connectors 21 are respectively connected to the in-vehicle devices 20. Connectors 21 are to be detachably connected to the plurality of connectors 12 respectively. If the connector 12 is connected to the connector 21, the electrical device 13 is connected to the in-vehicle device 20.

If the plurality of connectors 21 are respectively connected to the plurality of connectors 12, each of the plurality of in-vehicle devices 20 is connected to at least one of other in-vehicle devices through the electrical device 13.

As mentioned above, the electrical junction box 1 accommodates the electrical device 13 in the accommodating box 10, and interconnects the plurality of in-vehicle devices 20 via the electrical device 13 accommodated in the accommodating box 10. The in-vehicle devices 20 serve as external devices.

The in-vehicle device 20 is a battery, a lamp, a motor, or the like. Let us assume that one of the plurality of in-vehicle devices 20 is battery, and the remaining in-vehicle devices 20 are a lamp, a motor, and the like. As a first example, the electrical device 13 includes a plurality of fuses, and the battery is connected to the remaining in-vehicle devices 20 through the plurality of fuses. The electrical device 13 protects the remaining in-vehicle devices 20 from an overcurrent.

As a second example, the electrical device 13 is a DCDC converter that transforms a DC (direct current) voltage. In this case, the electrical device 13 transforms a voltage output from the battery, and outputs the transformed voltage to the remaining in-vehicle devices 20. As a third example, the electrical device 13 includes a plurality of switches, and the battery is connected to the remaining in-vehicle devices 20 through the plurality of switches. By turning each of the switches on or off, the in-vehicle device 20 to which power is supplied from the battery is changed.

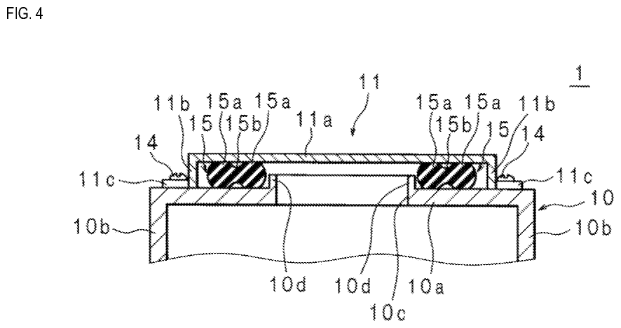

FIG. 3 is a partial cross-sectional view of the electrical junction box 1 taken along line A-A in FIG. 1. FIG. 4 is a partial cross-sectional view of the electrical junction box 1 taken along line B-B in FIG. 1. In FIGS. 3 and 4, a cross section of the upper portion of the electrical junction box 1 is shown. As shown in FIGS. 3 and 4, a rectangular opening 10c penetrating in the vertical direction is provided in a part of the upper wall 10a of the accommodating box 10. In the upper wall 10a of the accommodating box 10, a protruding wall 10d protrudes upward from the edge portion of the opening 10c. When the electrical junction box 1 is manufactured, various electric components constituting the electrical device 13 are put into the accommodating box 10 from the opening 10c.

As shown in FIGS. 1, 3 and 4, the lid 11 is in the form of box whose one side is open. In the lid 11, side walls 11b protrude downward from each side of the rectangular plate-like bottom wall 11a, and any adjacent two side walls 11b are connected. The lower end surface of the side wall 11b is in contact with the upper surface of the upper wall 10a of the accommodating box 10. The bottom wall 11a of the lid 11 is arranged above the protruding wall 10d of the accommodating box 10, and covers the opening 10c. Each side wall 11b faces the protruding wall 10d at an interval. The width in the vertical direction of the side wall 11b is longer than the width in the vertical direction of the protruding wall 10d of the accommodating box 10.

In the lid 11, two plate-like protruding walls 11c protrude outward from the lower end of one side wall 11b of the two side walls 11b facing each other. Also, two plate-like protruding walls 11c protrude outward from the lower end of the other side wall 11b. The lower surfaces of the four protruding walls face the upper surface of the upper wall 10a of the accommodating box 10.

A through hole 11d penetrates each of the four protruding walls 11c in the vertical direction. In the upper wall 10a of the accommodating box 10, screw holes 10e are provided at positions corresponding to the respective through holes 11d. The through hole 11d and the screw hole 10e are continuous. The shaft of a screw 14 is inserted into the through hole 11d. The shaft of the screw 14 is fitted into the screw hole 10e corresponding to the through hole 11d through which that screw 14 is inserted. The head of the screw 14 is in contact with the upper surface of the protruding wall 11c of the through hole 11d.

In the manufacturing of the electrical junction box 1, the shaft of the screw 14 is inserted into the through hole 11d, and the shaft of the screw 14 is arranged in the corresponding screw hole 10e. Thereafter, the four screws 14 are tightened. As a result, the lid 11 is fixed to the upper wall 10a of the accommodating box 10, and closes the opening 10c of the accommodating box 10.

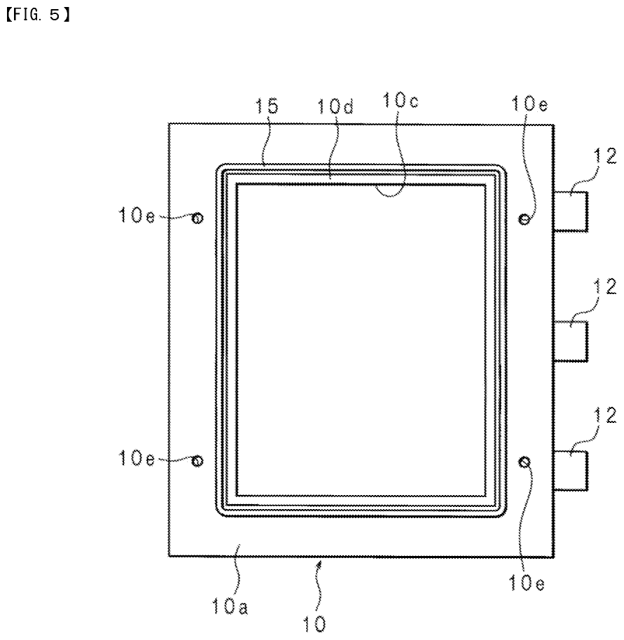

FIG. 5 is a plan view of the electrical junction box 1 from which the lid 11 is removed. As shown in FIGS. 3 to 5, an annular sealing member 15 is arranged on the upper surface of the upper wall 10a of the accommodating box 10 along the opening 10c. The sealing member 15 is an elastic body made of rubber and having water repellency. The sealing member 15 surrounds the protruding wall 10d of the accommodating box 10.

As shown in FIGS. 3 and 4, the sealing member 15 is in intimate contact with the upper surface of the upper wall 10a of the accommodating box 10 and the lower surface of the bottom wall 11a of the lid 11, and closes the gap between the upper wall 10a and the bottom wall 11a. Specifically, the sealing member 15 includes two abutting portions 15a that are in intimate contact with the upper surface of the upper wall 10a and the lower surface of the bottom wall 11a and closes the gap between the upper wall 10a and the bottom wall 11a, and a non-abutting portion 15b that is separated from the upper surface of the upper wall 10a and the lower surface of the bottom wall 11a. The abutting portions 15a and the non-abutting portion 15b are annular and arranged along the opening 10c. The non-abutting portion 15b connects the two abutting portions 15a. The upper surface of the upper wall 10a is an outer surface of the accommodating box 10. The lower surface of the bottom wall 11a is an inner surface of the lid 11.

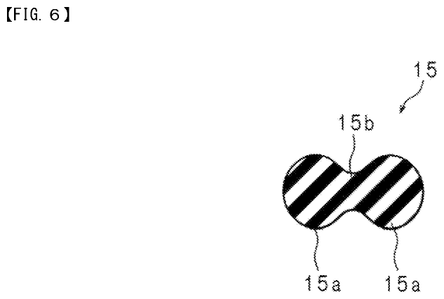

FIG. 6 is a cross-sectional view of the sealing member 15. The state of the sealing member 15 shown in FIG. 6 is a state in which the sealing member 15 is separated from the accommodating box 10 and the lid 11. If the sealing member 15 is separated from the accommodating box 10 and the lid 11, the width of the abutting portion 15a is longer than the width in the vertical direction of the side wall 11b of the lid 11. The width of the non-abutting portion 15b is shorter than the width in the vertical direction of the side wall 11b of the lid 11. Because the sealing member 15 is an elastic body, it is deformable.

As shown in FIGS. 3 and 4, if the four screws 14 are tightened and the lid 11 is fixed to the upper wall 10a of the accommodating box 10, force is applied to the abutting portions 15a of the sealing member 15 from the upper side and the lower side. As a result, the abutting portions 15a are deformed and reliably in intimate contact with the upper surface of the upper wall 10a of the accommodating box 10 and the lower surface of the bottom wall 11a of the lid 11. As mentioned above, in the electrical junction box 1, the non-abutting portion 15b is separated from the accommodating box 10 and the lid 11.

As shown in FIGS. 3 and 4, the sealing member 15 is arranged between the protruding wall 10d of the accommodating box 10 and each of the side walls 11b of the lid 11. The side wall 11b of the lid 11 faces the sealing member 15 at a distance in the direction along the upper surface of the upper wall 10a of the accommodating box 10. A gap is formed between the side wall 11b and the sealing member 15. The protruding wall 10d of the accommodating box 10 also faces the sealing member 15 at a distance in the direction along the upper surface of the upper wall 10a of the accommodating box 10. A gap is formed between the protruding wall 10d and the sealing member 15. The distance between the side wall 11b and the sealing member 15 is longer than the distance between the protruding wall 10d and the sealing member 15. The abutting portion 15a is arranged closer to the protruding wall 10d than to the side wall 11b. The side wall 11b and the protruding wall 10d respectively serve as an opposing wall and a second opposing wall.

As mentioned above, the lid 11 of the electrical junction box 1 is provided with the side walls 11b. For this reason, when a vehicle is washed with water, or when a vehicle runs in rain, no water directly contacts the sealing member 15, and thus the sealing member is less likely to be worn away.

As shown in FIG. 4, the lower end surface of the side wall 11b of the lid 11 are in contact with the upper surface of the upper wall 10a of the accommodating box 10. However, due to salt damage, the lower end surface of the side wall 11b or the upper surface of the upper wall 10a may be corroded, and water may enter the inside of the lid 11 from the gap between the upper wall 10a and the side wall 11b. As mentioned above, in the electrical junction box 1, the annular sealing member 15 is arranged on the upper surface of the upper wall 10a of the accommodating box 10 along the opening 10c, and is in intimate contact with the upper surface of the upper wall 10a of the accommodating box 10 and the lower surface of the bottom wall 11a of the lid 11. Accordingly, the entry of water into the accommodating box 10 is prevented.

Because a gap is formed between each side wall 11b of the lid 11 and the sealing member 15, the impact of water hitting the sealing member 15 is weak. For this reason, the sealing member 15 is even less likely to be worn away. In the vehicle, the electrical junction box 1 is arranged such that the accommodating box 10 is on the lower side. Also, in the lid 11 of the electrical junction box 1, the side wall 11b protrudes downward from each side of the bottom wall 11a. For this reason, water is less likely to be accumulated in the gap between the side wall 11b of the lid 11 and the sealing member 15. As a result, in the inside of the lid 11, the accommodating box 10 and the lid 11 are less likely to be corroded.

As another configuration in which the positioning of the sealing member 15 is further facilitated, a configuration is conceivable in which a second protruding wall, which protrudes upward from the upper surface of the upper wall 10a of the accommodating box 10 and faces the protruding wall 10d at a distance, is provided. In this configuration, the upper wall 10a, the protruding wall 10d and the second protruding wall form a groove. Because the sealing member 15 is positioned by fitting the sealing member 15 into the groove, the manufacturing is facilitated. However, in this configuration, water may accumulate in the groove. Thus, the accommodating box 10 and the lid 11 are easily corroded. Because the second protruding wall is not provided in the electrical junction box 1, as mentioned above, water is less likely to be accumulated in the gap between the side wall 11b of the lid 11 and the sealing member 15.

As mentioned above, the protruding wall 10d is provided in the accommodating box 10 of the electrical junction box 1. For this reason, the sealing member 15 can be easily positioned when manufacturing the electrical junction box 1.

Also, because the sealing member 15 is in intimate contact with the accommodating box 10 and the lid 11 at plural locations, the entry of water into the accommodating box 10 can be reliably prevented.

Note, that to manufacture electrical junction box 1 more easily, a mark indicating a position in which the sealing member 15 is to be arranged may also be provided on the upper surface of the upper wall 10a of the accommodating box 10. A mark (line) surrounding the protruding wall 10d may also be provided on the upper surface of the upper wall 10a of the accommodating box 10, for example. In this configuration, the sealing member 15 is arranged between the protruding wall 10d and the mark. As a result, the sealing member 15 is more easily positioned.

### Second Embodiment

In the first embodiment, the sealing member 15 is arranged on the upper surface of the upper wall 10a of the accommodating box 10. However, the arrangement position of the sealing member 15 is not limited to the upper surface of the upper wall 10a.

Hereinafter, points of the second embodiment that are different from the first embodiment will be described. Configurations aside from those described hereinafter are the same as in the first embodiment. For this reason, constituent elements that are the same as in the first embodiment will be given the same reference signs as in the first embodiment, and descriptions thereof will be omitted.

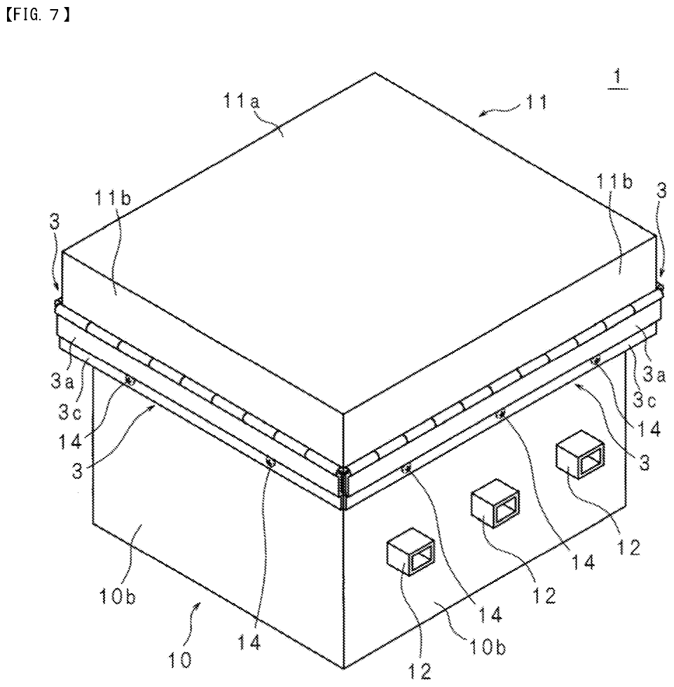

FIG. 7 is a perspective view showing the appearance of an electrical junction box 1 in the second embodiment. Similar to the electrical junction box 1 according to the first embodiment, an electrical junction box 1 according to the second embodiment includes an accommodating box 10 and a lid 11. The electrical device 13 is accommodated in the accommodating box 10. The electrical junction box 1 interconnects a plurality of in-vehicle devices 20 via the electrical device 13 accommodated in the accommodating box 10. FIG. 7 shows an example in which the number of connectors 12 is three.

In the second embodiment, the lid 11 covers the upper side of the accommodating box 10 and upper portions of the side walls 10b of the accommodating box 10 from the outside, and is fixed to the side walls 10b of the accommodating box 10 by a plurality of screws 14. Similar to the first embodiment, the outer surfaces of the accommodating box 10 and the lid 11 are coated with a paint for preventing salt damage, and thus corrosion of the outer surfaces caused by salt is prevented.

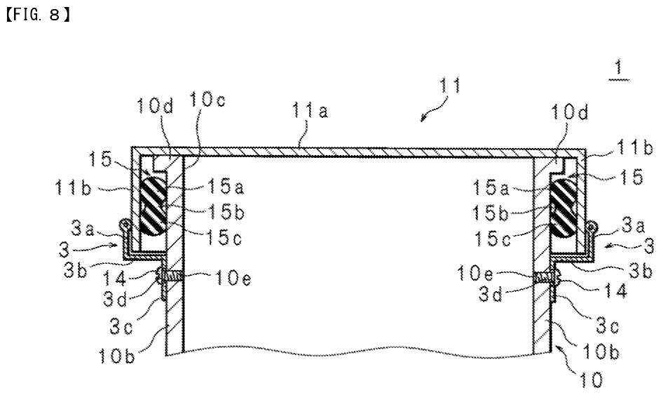

FIG. 8 is a partial cross-sectional view of the electrical junction box 1. FIG. 8 shows the cross section of the upper part of the electrical junction box 1. As shown in FIGS. 7 and 8, the accommodating box 10 is in the form of a box whose entire top side is open. An opening 10c of the accommodating box 10 penetrating in the vertical direction is provided in the entire top side of the accommodating box 10. In the accommodating box 10, a protruding wall 10d protrudes outward from the edge portion of the opening 10c. The protruding wall 10d extends around the peripheral edge of the opening 10c.

Similar to the first embodiment, the lid 11 is in the form of box whose one side is open. In the lid 11, a side wall 11b protrudes downward from each side of a rectangular plate-like bottom wall 11a. Furthermore, the adjacent two side walls 11b are connected. As shown in FIG. 8, the lower surface of the bottom wall 11a is in contact with the upper end surfaces of the side walls 10b of the accommodating box 10. The protruding wall 10d protrudes along the lower surface of the bottom wall 11a. The upper surface of the protruding wall 10d is in contact with the lower surface of the bottom wall 11a. Each side wall 11b faces the corresponding side wall 10b of the accommodating box 10 at a distance.

A fixing member 3 for fixing the lid 11 to the accommodating box 10 is rotatably attached to each side wall 11b of the lid 11. As shown in FIG. 8, the fixing member 3 has an S-shaped cross section. A rectangular first cover plate 3a of the fixing member 3 covers a lower part of the side wall 11b from the outside. The upper side portion of the first cover plate 3a is rotatably attached to the outer surface of the side wall 11b. The fixing member 3 rotates about the upper side portion of the first cover plate 3a.

In the fixing member 3, a protruding plate 3b protrudes from the lower side portion of the first cover plate 3a toward the side wall 10b of the accommodating box 10. The protruding plate 3b closes the gap between the side wall 10b of the accommodating box 10 and the side wall 11b of the lid 11. A second cover plate 3c protrudes downward along the side wall 10b from the side portion of the protruding plate 3b on the side wall 10b side of the accommodating box 10. The plate surface of the second cover plate 3c is in contact with the outer surface of the side wall 10b of the accommodating box 10.

The second cover plate 3c of the fixing member 3 is provided with a through hole 3d penetrating in the direction perpendicular to the side wall 10b and the plate surface of the second cover plate 3c. In the side wall 10b of the accommodating box 10, a screw hole 10e is provided at a position corresponding to the through hole 3d of the fixing member 3 covering that side wall 10b. The through hole 3d and the screw hole 10e are continuous. The shaft of a screw 14 is inserted into the through hole 3d. The shaft of the screw 14 is fitted into the screw hole 10e corresponding to the through hole 3d through which that screw 14 is inserted. The head of the screw 14 is in contact with the outer surface of the second cover plate 3c of the through hole 3d.

In the manufacturing of the electrical junction box 1, the shaft of the screw 14 is inserted through the through hole 3d, and the shaft of the screw 14 is arranged in the corresponding screw hole 10e. After that, these screws 14 are tightened. As a result, the lid 11 is fixed to the side walls 10b of the accommodating box 10, and closes the opening 10c of the accommodating box 10.

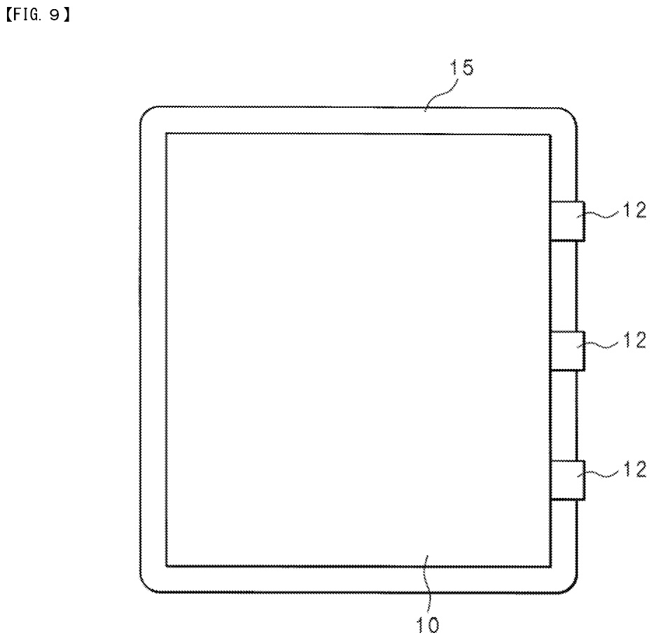

FIG. 9 is a bottom view of the electrical junction box 1 from which the lid 11 is removed. As shown in FIGS. 8 and 9, on the outer surfaces of the side walls 10b of the accommodating box 10, an annular sealing member 15 is arranged along the opening 10c. The sealing member 15 is arranged on the lower side of the protruding wall 10d of the accommodating box 10.

A sealing member 15 of the second embodiment is configured in the same manner as that of the first embodiment. In the second embodiment, two annular abutting portions 15a are aligned in the vertical direction, and an annular non-abutting portion 15b connects the two abutting portions 15a. As shown in FIG. 8, the two abutting portions 15a are in intimate contact with the outer surfaces of the side walls 10b of the accommodating box 10 and the inner surfaces of the side walls 11b of the lid 11 facing these side walls 10b, and close the gaps between the side walls 10b and the side walls 11b. The non-abutting portion 15b is separated from the outer surfaces of the side walls 10b of the accommodating box 10 and the side walls 11b of the lid 11.

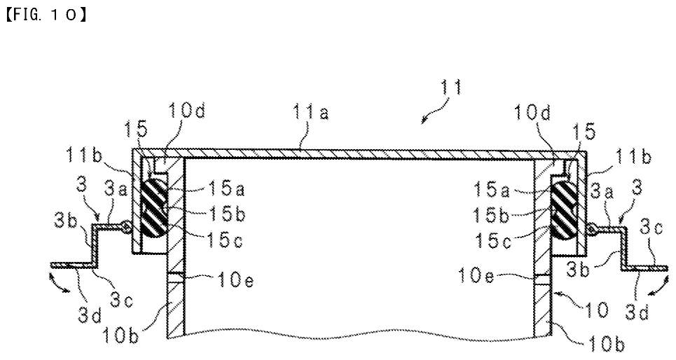

FIG. 10 is a view explaining the manufacturing method of the electrical junction box 1. In the second embodiment, if the sealing member 15 is separated from the accommodating box 10 and the lid 11, the width of the abutting portion 15a is longer than the distance between outer surface of the side wall 10b of the accommodating box 10 and the inner surface of the side wall 11b of the lid 11. The width of the non-abutting portion 15b is shorter than the distance between the outer surface of the side wall 10b and the inner surface of the side wall 11b. As mentioned in the first embodiment, because the sealing member 15 is an elastic body, it is deformable.

In the manufacturing of the electrical junction box 1, the sealing member 15 is arranged on the lower side of the protruding wall 10d on the outer surface of the accommodating box 10. Next, as shown in FIG. 10, the lid 11 in which the fixing members 3 are rotated outward is fitted into the accommodating box 10 from the upper side. As mentioned above, if the sealing member 15 is separated from the accommodating box 10 and the lid 11, the width of the abutting portion 15a is longer than the distance between the outer surface of the side wall 10b of the accommodating box 10 and the inner surface of the side wall 11b of the lid 11. Accordingly, if the lid 11 is fitted into the accommodating box 10, a force is applied to the abutting portions 15a from the side walls of the accommodating box 10 and the side walls 11b of the lid 11. As a result, the abutting portions 15a are deformed, and are reliably in intimate contact with the outer surfaces of the side walls 10b of the accommodating box 10 and the inner surfaces of the side walls 11b of the lid 11. As mentioned above, in the electrical junction box 1, the non-abutting portion 15b is separated from the accommodating box 10 and the lid 11.

After the lid 11 is fitted into the accommodating box 10, as shown in FIG. 8, the fixing members 3 are rotated downward to bring the second cover plates 3c into contact with the side walls 10b of the accommodating box 10. Next, the shaft of the screw 14 is inserted into the through hole 3d of the fixing member 3, and the shaft of the screw 14 is arranged in the screw hole 10e of the side wall 10b corresponding to the through hole 3d through which the shaft of the screw 14 is inserted. Then, the lid 11 is fixed to the accommodating box 10 by tightening the screws 14, and the electrical junction box 1 is manufactured.

As shown in FIG. 8, the sealing member 15 is arranged between the protruding wall 10d of the accommodating box 10 and the protruding plates 3b of the lid 11. Each protruding plate 3b of the lid 11 faces the sealing member 15 at a distance in the direction along the outer surface of the side wall 10b of the accommodating box 10. A gap is formed between the protruding plate 3b and the sealing member 15. The protruding wall 10d of the accommodating box 10 also faces the sealing member 15 at a distance in the direction along the outer surface of the side wall 10b of the accommodating box 10. A gap is formed between the protruding wall 10d and the sealing member 15. The distance between the protruding plate 3b and the sealing member 15 is longer than the distance between the protruding wall 10d and the sealing member 15. The abutting portion 15a is arranged closer to the protruding wall 10d than to the side wall 11b. In the second embodiment, the protruding plates 3b serve as opposing walls.

As mentioned above, the lid 11 of the electrical junction box 1 is provided with the protruding plates 3b. For this reason, when a vehicle is washed with water, or when a vehicle runs in rain, no water directly contacts the sealing member 15, and thus the sealing member is less likely to be worn away.

As mentioned above, in the electrical junction box 1, the annular sealing member 15 is arranged on the outer surfaces of the side walls 10b of the accommodating box 10 along the opening 10c, and is in intimate contact with the outer surfaces of the side walls 10b of the accommodating box 10 and the inner surfaces of the side walls 11b of the lid 11. Accordingly, the entry of water into the accommodating box 10 is prevented.

Because a gap is formed between the protruding plate 3b of the lid 11 and the sealing member 15, the impact of water hitting the sealing member is weak. For this reason, the sealing member 15 is even less likely to be worn away. In the vehicle, the electrical junction box 1 is arranged such that the accommodating box 10 is on the lower side. For this reason, water is less likely to be accumulated in the gap between the protruding plate 3b of the lid 11 and the sealing member 15. As a result, in the inside of the lid 11, the accommodating box 10 and the lid 11 are less likely to be corroded.

As mentioned above, the protruding wall 10d is provided in the accommodating box 10 of the electrical junction box 1. For this reason, the positioning of the sealing member 15 is easy in manufacturing the electrical junction box 1.

Also, because the sealing member 15 is in intimate contact with the accommodating box 10 and the lid 11 at plural locations, the entry of water into the accommodating box 10 can be reliably prevented.

Note, that in the first and second embodiments, the number of the abutting portions that the sealing member 15 has is not limited to two. The number of the abutting portions may also be one, or three or more. If the number of the abutting portion 15a is one, the sealing member 15 has no non-abutting portion 15b. If the sealing member 15 has three or more abutting portions 15a, the number of non-abutting portions 15a is one less than the number of the abutting portions 15a. In this case, each non-abutting portion 15b connects two abutting portions 15a of the three or more abutting portions 15a.

The sealing member 15 may be an elastic body made of rubber and having water repellency. For this reason, the material forming the sealing member 15 is not limited to rubber.

The sealing member 15 may also be in contact with the protruding wall 10d of the accommodating box 10. The accommodating box 10 may also have no protruding wall 10d. Also in this case, a configuration is realized in which the entry of water into the accommodating box 10 is reliably prevented.

It is not necessary for all the connectors 12 to be provided on one side wall 10b of the accommodating box 10. Each side wall 10b may also have at least one connector 12, for example.

The first and second embodiments that were disclosed are to be considered exemplary in all respects and in no way limiting. The scope of the present disclosure is defined by the scope of the appended claims and not by the above description, and all changes that fall within the same essential spirit as the scope of the claims are included therein.

What is claimed is:

1. An electrical junction box for accommodating an electrical device and interconnecting a plurality of external devices via the accommodated electrical device, the electrical junction box comprising:
an accommodating box having an opening and accommodating the electrical device;
a lid closing the opening; and
an annular sealing member that is arranged along the opening on an outer surface of the accommodating box, and that is in intimate contact with the outer surface of the accommodating box and an inner surface of the lid,
wherein the lid includes an opposing wall facing the sealing member at a distance in a direction along the outer surface of the accommodating box.

2. The electrical junction box according to claim 1, wherein
the accommodating box includes a second opposing wall that protrudes from an edge portion of the opening and that faces the sealing member, and
the sealing member is arranged between the opposing wall and the second opposing wall.

3. The electrical junction box according to claim 2, wherein
the distance between the sealing member and the opposing wall is longer than the distance between the sealing member and the second opposing wall.

4. The electrical junction box according to claim 1, wherein
the sealing member includes:
a plurality of annular abutting portions in intimate contact with the accommodating box and the lid; and
an annular non-abutting portion that is connected to two of the plurality of abutting portions, and that is separated from the accommodating box and the lid.

5. The electrical junction box according to claim 1, wherein
the lid is in the form of box whose one side is open, and
the opposing wall is the side wall of the lid.

6. The electrical junction box according to claim 2, wherein
the sealing member includes:
a plurality of annular abutting portions in intimate contact with the accommodating box and the lid; and
an annular non-abutting portion that is connected to two of the plurality of abutting portions, and that is separated from the accommodating box and the lid.

7. The electrical junction box according to claim 3, wherein
the sealing member includes:
a plurality of annular abutting portions in intimate contact with the accommodating box and the lid; and
an annular non-abutting portion that is connected to two of the plurality of abutting portions, and that is separated from the accommodating box and the lid.

8. The electrical junction box according to claim 2, wherein
the lid is in the form of box whose one side is open, and
the opposing wall is the side wall of the lid.

9. The electrical junction box according to claim 3, wherein
the lid is in the form of box whose one side is open, and
the opposing wall is the side wall of the lid.

10. The electrical junction box according to claim 4, wherein
the lid is in the form of box whose one side is open, and
the opposing wall is the side wall of the lid.
